(19) United States
(12) Patent Application Publication
(10) Pub. No.: US 2026/0008301 A1
(43) Pub. Date: Jan. 8, 2026

(54) SPOKED WHEEL TRUING SYSTEM

(71) Applicant: BERD L. L. C., Hopkins, MN (US)

(72) Inventors: Charles S. Spanjers, Edina, MN (US); Allison L. Horner, Minneapolis, MN (US); Bradley L. Guertin, Roseville, MN (US); Kyle D. Olson, St. Louis Park, MN (US); Keegan A. Krol, Plymouth, MN (US); David L. Danks, Minnetonka, MN (US); Nicholas C. Vetter, Minneapolis, MN (US)

(21) Appl. No.: 19/130,023

(22) PCT Filed: Oct. 11, 2024
(86) PCT No.: PCT/US2024/051041

§ 371 Date: May 14, 2025

Related U.S. Application Data
(60) Provisional application No. 63/590,257, filed on Oct. 13, 2023.

(51) Int. Cl. B60B 31/00; B60B 31/02

(52) U.S. Cl. CPC B60B 31/005; B60B 31/02; B60B 2320/12; B60B 2340/18

(57) ABSTRACT

A spoked wheel truing system includes a client computer configured with a graphical user interface to collect data on a wheel. The client computer is configured to communicate with a remote server to send the collected data to the remote server, and receive from the remote server processed data comprising instructions on truing the wheel.

### CROSS-REFERENCE TO RELATED APPLICATION

This Application claims priority to U.S. provisional patent application Ser. No. 63/590,257, filed Oct. 13, 2023, the contents of which are incorporated herein in its entirety.

### BACKGROUND

A wheel is generally composed of a hub, a rim, and a plurality of an equal number of spokes and nipples. By turning the nipples, which the spokes are threaded into, the roundness (i.e., trueness), the centering of the rim with respect to the hub, and the spoke tension of the wheel can be altered. This process is typically performed iteratively by a skilled operator. Using gauges or other instruments to measure the trueness of the wheel, the operator chooses a location on the wheel to attempt to improve the runout or spoke tension variation, and tightens or loosens one or more spoke nipples. The operator then re-evaluates the trueness of the wheel and continues the process of making adjustments to the nipples and re-evaluating the runout of the wheel until the wheel meets pre-determined specifications, or the operator otherwise decides to stop the process, for example due to time constraints.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in deter-mining the scope of the claimed subject matter. The claimed subject matter is not limited to implementations that solve any or all disadvantages noted in the Background.

In one aspect, a spoked wheel truing system includes a client computer configured with a graphical user interface to collect data on a spoked wheel. The client computer is configured to communicate with a remote server to send the collected data to the remote server, and receive from the remote server processed data comprising instructions on truing the spoked wheel.

Implementations may include one or more of the following features. The client computer may be further configured to collect data on the spoked wheel by collecting wheel parameter data and collecting wheel technical data. The client computer may be further configured to collect wheel parameter data defining the spoked wheel including at least one of wheel brand, wheel size, number of spokes, type of spokes, wheel hub type, rim type, and spoke lacing pattern. The client computer may be further configured to collect wheel technical data including at least one of a dish measurement for the spoked wheel, radial and lateral true data for the spoked wheel, and spoke tension for spokes of the spoked wheel. The client computer may be further configured to collect spoke tension for spokes of the spoked wheel from a tensiometer. The client computer may receive spoke tension data from the tensiometer through operation of a coupled transmitter on the tensiometer. The client computer may be configured to process the received spoke tension data from the tensiometer and determine when the spoke tension data is stable based on a stability criteria.

Implementations of the spoked wheel truing system may further comprise a rotational positioning device affixable at a known location on the spoked wheel, wherein the client computer is further configured to identify the presence of the rotational positioning device to allow for identification of the known location. The rotational positioning device may be a rubber band. A spoke adjustment tool may be coupled to the client computer and controlled thereby, the spoke adjustment tool configured to perform the truing instructions received by the client computer on spokes of the spoked wheel. The spoke adjustment tool may be a drill.

The generated instructions may comprise a number of turns to be imparted to at least a spoke of the spoked wheel. The generated instructions may comprise a number of turns to be imparted to a subset of the spokes of the spoked wheel. The generated instructions may comprise a number of turns to be imparted to each spoke of the spoked wheel.

The client computer may be further configured to transmit the collected data to the remote server, and to receive processed data determined by identifying the spoked wheel with the wheel parameter data, retrieving predetermined wheel technical data for a properly trued wheel from a database resident on the remote server, and applying the wheel technical data to the predetermined wheel technical data for generating the instructions for truing the spoked wheel.

In another aspect, a method of truing a spoked wheel includes obtaining wheel data at a client computer, providing the wheel data to a remote server, and receiving from the remote server processed instructions for truing the spoked wheel determined by the remote server.

Implementations of the method may include one or more of the following features. The instructions may be displayed on a graphical user interface of the client computer, the instructions. The method may include truing the spoked wheel with displayed instructions. The method may include truing the spoked wheel with the instructions. The instructions may include a number of turns to be imparted to each spoke of the spoked wheel. The instructions may include a number of turns to be imparted to at least a spoke of the spoked wheel. The instructions may include a number of turns to be imparted to a subset of the spokes of the spoked wheel. Processed instructions received from the remote computer may include wheel data information compared to a database of predetermined wheel technical data for a properly trued wheel, the database resident on the remote server, and applying the wheel technical data to the predetermined wheel technical data for generating the instructions for truing the spoked wheel.

Obtaining wheel data may include obtaining wheel parameter data and obtaining wheel technical data. Obtaining wheel data may be performed by initiating wheel technical data measurements at a graphical user interface of the client computer, the graphical user interface operating on software at the client computer to operate a system for obtaining the wheel technical data measurements. Obtaining wheel data may include collecting wheel parameter data and collecting wheel technical data. Collecting wheel parameter data may include collecting data defining the spoked wheel including at least one of wheel brand, wheel size, number of spokes, type of spokes, wheel hub type, rim type, and spoke lacing pattern. Collecting wheel technical data may include collecting at least one of a dish measurement for the spoked wheel, radial and lateral true data for the spoked wheel, and spoke tension for spokes of the spoked wheel.

In another aspect, a graphical user interface for a spoked wheel truing system includes a plurality of input and data screens configured to display wheel data and to prompt for user data entry of wheel data, and a display for generated instructions provided by a truing module.

In another aspect, a spoked wheel truing system includes a computer having a processor, and a memory storing a computer readable instructions configured to collect data on a spoked wheel, and to process the collected data to generate instructions on truing the spoked wheel. The spoked wheel truing system further includes a graphical user interface configured to control operation for truing the spoked wheel.

This summary is not intended to describe each disclosed embodiment or every implementation of power and signal distribution hubs as described herein. Many other novel advantages, features, and relationships will become apparent as this description proceeds. The figures and the description that follow more particularly exemplify illustrative embodiments.

### BRIEF DESCRIPTION OF THE DRAWINGS

FIG. 1 is a flow chart diagram of a method of truing a wheel according to an embodiment of the present disclosure;

FIG. 2 is a representative screen of a graphical user interface according to an embodiment of the present disclosure;

FIG. 3 is flow chart diagram of collection of lateral and radial displacement data according to an embodiment of the present disclosure;

FIG. 4 is a flow chart diagram of a method for collecting tensiometer data 104 with a digital tensiometer that is connected to a computer according to an embodiment of the present disclosure;

FIG. 5 is a flow chart diagram of method for collecting dish data according to an embodiment of the present disclosure;

FIG. 6 is a block diagram of a computer on which embodiments of the present disclosure may be practiced;

FIG. 7 is a block diagram of a client/server system on which embodiments of the present disclosure may be practiced;

FIG. 8 is a flow chart diagram of a method of truing a wheel according to an embodiment of the present disclosure; and

FIG. 9 illustrates a representative system for truing a wheel.

### DETAILED DESCRIPTION

The embodiments of the present disclosure provide a system for truing spoked wheels that includes collecting data on the wheel and its configuration, and providing instructions for wheel truing after determination of proper truing based on a database of known wheels and the collected data.

Methods are described herein for truing wheels that are significantly more efficient than current methods. In one embodiment, a method uses a client-server relationship wherein the client collects data on a wheel and the server processes the data to determine the optimal number of turns on each spoke such that a wheel may be trued in a single pass around the wheel. The server holds a database of wheel information from many clients which it uses, in part, as input into its algorithm for computing the optimal turns on each spoke. The results are then sent back to the client where the wheel can be trued quickly with an operator-controlled handheld drill programmed with the optimal number of turns for each spoke. This method of truing wheels using artificial intelligence can be performed with a non-skilled operator and it does not require large automation equipment yet it is usually much faster than the traditional iterative method of manually truing wheels. Furthermore, it is generic in that many wheels if not most types of bicycle, motorcycle, or other spoked wheels may be trued with this method.

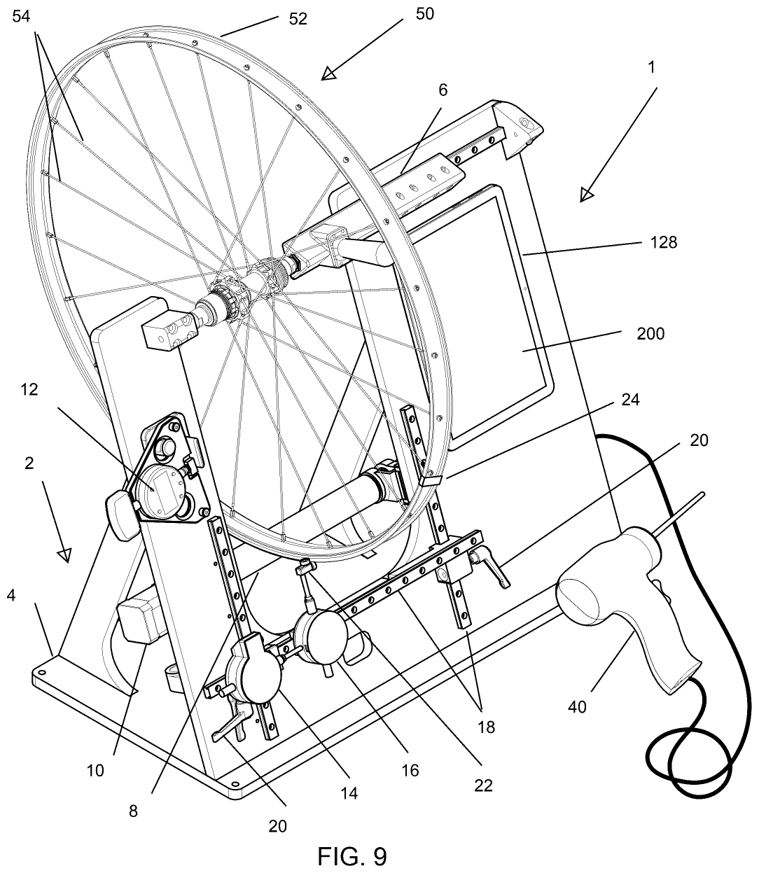

FIG. 9 illustrates a representative system 1 for truing a wheel 50. The system 1 operates as described above by following one or more of the methods or steps described herein. System 1 comprises in one embodiment a stand 2 on which a wheel 50 to be trued is mounted. Stand 2 includes base 4 and hub mount 6.

Stand 2 further includes mounted thereon, in one embodiment, a client computer 128 having a graphical user interface 200 (GUI), as described above. It should be understood that while client computer 128 is shown mounted to stand 2, it may be mounted elsewhere or separately without departing from the scope of the disclosure. Client computer 128 is coupled in one embodiment to a spoke adjustment tool, such as but not limited to a drill 40.

When a wheel 50 is mounted into system 1, the wheel 50 is adjusted so that the rim 52 thereof is contacted by roller 8 of stand 2. Roller 8 is spun by a roller motor 10 to impart a spin to the wheel 50 for gathering data including the parameters described above. Client computer 128 controls the operation of the roller 8 and roller motor 10. A tensiometer 12 is provided on stand 2 for taking tension readings of spokes as described above.

A lateral sensor 14 and a radial sensor 16 are movably mounted to stand 2 using rails 18. Rails 18 are slidably adjustable, and are securable in position by closing levers 20. In an operating position, the sensors 14, 16 are adjusted via the rails to place a common contact 22 for the lateral sensor 14 and radial sensor 16 in proper position at the rim 54 to measure both lateral and radial positions of the wheel as it is spun.

A rotational positioning device 24 is placed in one embodiment around the rim 54 at a known position thereon. When the rotational position device 24 passes the sensor contact 22, the spike in position is noted so that the system 1 knows when that particular rim position has passed the sensors. Using this, the number of rotations of the wheel 50 may be determined, along with additional information such as rotational speed, that may be used as described herein in truing the wheel 50. The rotational positioning device 24 is in one embodiment a band, such as a rubber band, that has a thickness sufficient to be larger than a rotational lateral or radial deviation in the wheel, such as to allow for the rotational positioning device 24 to be used for determining revolutions of the wheel 50.

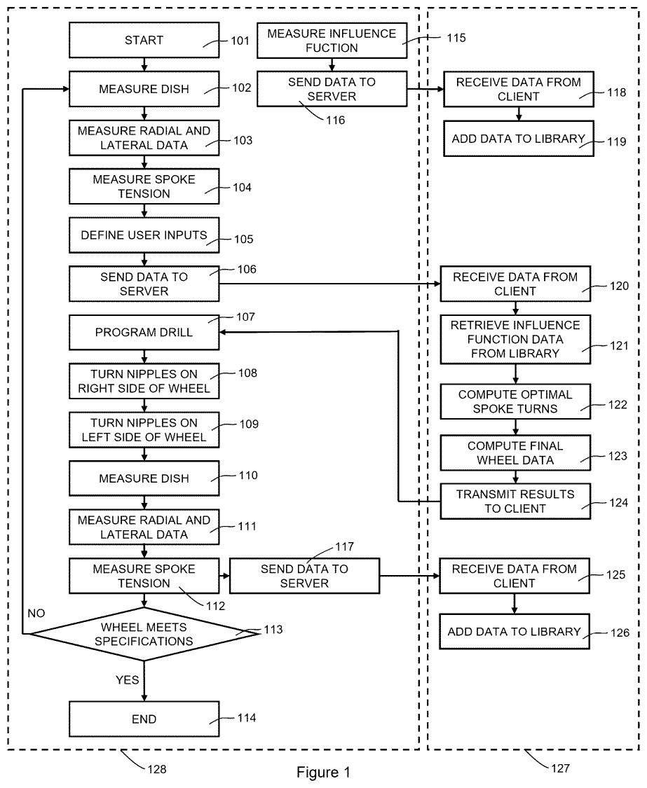

FIG. 1 is a block diagram of one example of an improved method for truing a wheel. The term wheel can refer to a bicycle wheel (e.g., wheel 50), motorcycle wheel, or any other type of spoked wheel with adjustable nipples. In one embodiment, the method and system comprise a client computer in communication with a server. Although such architecture can have benefits, it should be understood that in an alternative embodiment depending on features to be implemented, computer(s) could be used without connection to a server, where one or more functions provided by the server described below are performed by the computer(s) used by the operator.

In a first illustrative embodiment, the client computer or program 128 (hereinafter client), after start 101, starts the process to measure dish 102 (i.e., the centering of the rim 52 over the mid-point hub). While it is often desirable to have the mid-point of the rim 52 as close as possible to centered over the mid-point of the hub, some vehicles may specify that dish is offset such that the rim 52 is a specified distance from center. Nevertheless, the process of measuring dish is to compare the actual centering of the rim/hub compared to the desired value.

Dish can be measured by a trained operator by visually inspecting the gap between a specially designed tool for measuring dish and the hub. This gap, which might be less than 0.5 mm, is difficult to quantify precisely by visual inspection, so in one embodiment, dish is measured with a digital electronic indicator with a precision of 0.1 mm or better. The digital indicator is connected to a computer (e.g., client computer 128) in one embodiment. In another embodiment, a reading can be taken with a press of a foot pedal or other simple human input coupled to a sensor or the like when the operator is ready to take the measurement. In one embodiment, the operator might place a wheel 50 horizontally on a gauge. The hub will depress the indicator, and then the operator will press a foot pedal to record the measurement on the computer. In another embodiment, a gauge separate from a truing stand might not be used. Instead, an operator may place a wheel 50 in a truing stand 2 outfitted with an electronic indicator such that the electronic indicator is touching one side of the rim 52. Then, the operator flips the wheel 50 such that the electronic indicator is now touching the opposite side of the rim 52. The difference in displacement between the two measurements may then be correlated to the dish. In a further possible addition to this embodiment, the truing stand 2 may be outfitted with a device (e.g., roller 8 and motor 10) that rotates the wheel 50 such that the electronic indicator takes measurements along the entire circumference of the wheel 50. Now the average displacements on the two sides of the wheel 50 may be compared to give a dish measurement that should be more reflective of the entirety of the wheel 50 than measuring in a single location.

The next step of the process is to acquire radial and lateral true data 103 for the wheel. Radial and lateral trueness (also referred to as runout) typically refers to the up-and-down and side-to-side displacements, respectively, of a rim 52 with respect to a fixed object next to the rim 52 while the wheel 50 is spinning in a truing stand (e.g., stand 2). Methods for measuring runout include visual inspection of the gap between the rim and a nearby fixed object or using analog or digital dial indicators (e.g., sensor contact 22 for lateral sensor 14 and radial sensor 16) that touch the rim 52 while the wheel 50 is spinning to quantify the amount of radial and lateral displacement. In one embodiment, digital electronic indicators 14 and 16 (especially those connected to the computer) are used for both radial (sensor 16) and lateral (sensor 14) in this configuration. Many measurements of both radial and lateral true are taken around the circumference of the wheel 50, and these measurements are taken at defined positions around the wheel. For example, on a wheel with 28 spokes, it is convenient to take 28 measurements with digital electronic indicators measuring lateral runout and radial runout at the position of each spoke. These measurements can then be stored in a data table where for each spoke position there is a corresponding lateral measurement and radial measurement. In some scenarios it may be difficult to collect lateral or radial runout, so one of these measurements may be omitted. For example, it might be difficult to measure the radial runout of a wheel mounted with a tire because the tire is seated in a position that would physically interfere with placing an indicator to measure the radial runout. In this example, the system might only collect and use lateral data for the purposes of truing the wheel 50.

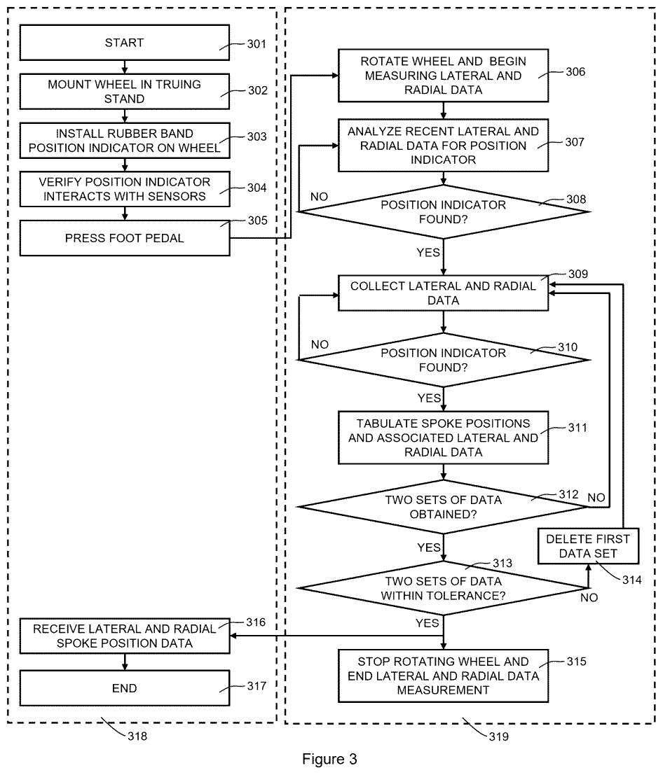

In one embodiment, the wheel 50 is spun in a truing machine 1 by a motor 10 with a roller 8 contacting the rim 52, and an infrared sensor detects the position of each spoke while the lateral and radial digital electronic indicators collect data simultaneously on wheel displacement. In another embodiment, a magnet mounted to the wheel and a magnetic sensor mounted to a stationary mounting point is used to detect the passing of a certain location on the wheel. Interpolation in time or space may be used to determine the lateral and radial positions at each of the locations of each spoke around the wheel, because the relative spacing of the spokes is even or otherwise known for a particular type of wheel. In another embodiment, an infrared or magnetic sensor is not necessary because an object (e.g., rotational positioning device 24) could be placed on or attached to the outside of the rim 52. This object would produce a bump, or localized protrusion, on the outside of the rim 52 that is easily detectable by the lateral and/or radial sensors 14, 16. For example, a rubber band wrapped around the rim at the position of the valve hole produces a spike in the radial and lateral sensor value with a magnitude of approximately 1 mm when the rubber band touches the sensor. This spike is a larger spike than is usually present on a rim (from seams or other defects, for example). Other size rubber bands could be used to produce smaller or larger spikes or characteristic signals to help differentiate from features already present on the rim. In this example of using a rubber band in conjunction with the lateral and/or radial sensor to determine the position of the valve hole, the lateral and radial sensor values at each spoke could then be determined by collecting data as the wheel spins around its entire circumference at a uniform rate. For example, 800 data points might be collected if the wheel 50 is spun at a rate of one revolution per four seconds and data is collected at a rate of one data point every 5 milliseconds. For the purposes of determining a number of spoke turns for each spoke 54, in one embodiment, a data point is obtained at every spoke location, so interpolation may be used to tabulate a list of the lateral and radial sensor value at each spoke position by using assumptions or known data regarding the spacing of spokes and nipples with respect to the position of the valve hole. An example of this scheme is shown in FIG. 3 and described further below.

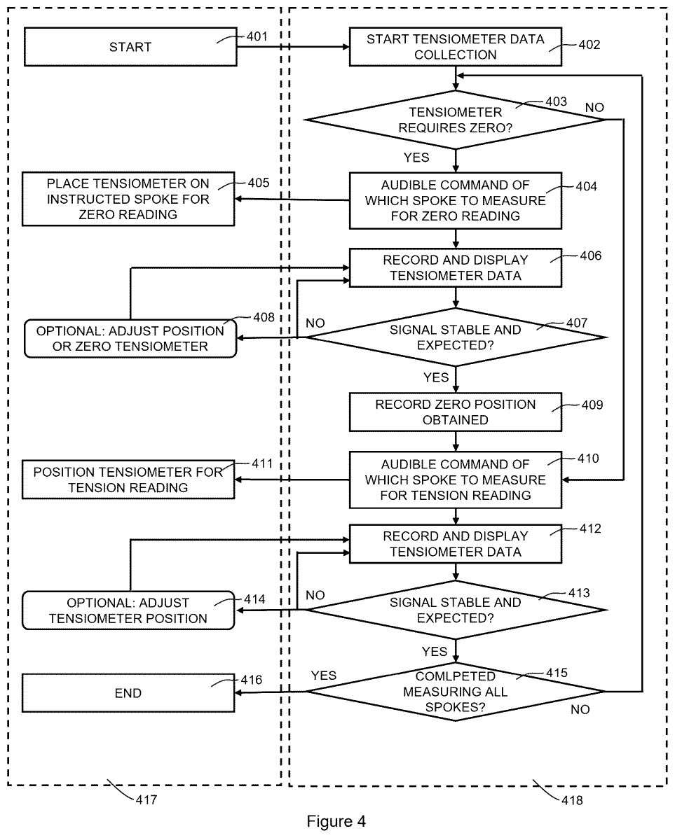

The next step is to measure the spoke tension 104 of each of the spokes 54 in the wheel 50. The spoke tension may be measured with many different devices including analog and digital 3-point bending devices that measure displacement with an applied load. In one embodiment, tension is measured with an electronic digital tensiometer 12 connected to a computer (e.g., client computer 128). Measurements can be transmitted directly to a computer using a coupled foot pedal or instead by means of a process (described in FIG. 4) which decides if the signal is stable and then transmits the measurement to a computer once a certain criteria for stability has been met. Typically an operator would hold the tension measuring device 12 in one hand and manually place the device on each spoke 54, but other methods for measuring or estimating tension exist, for example, using sound frequency of a plucked spoke which is correlated with tension. If measuring manually it can be convenient to measure the tension of all spokes 54 on one side of the wheel 50 followed by all spokes 54 on the other side of the wheel 50. Such other methods may be employed with embodiments of the present disclosure without departing from the scope thereof.

After measuring dish 102, taking lateral and radial data 103, and measuring tension 104, the next step is to define user inputs 105. The user may need to define certain parameters such as the number of spokes 54 in the wheel 50, the type of spokes 54 in the wheel 50 (e.g., 1.8 mm round metal spokes, 2.0 mm braided fiber polymer spokes, etc.), the type of hub used in the wheel 50, the type of rim 52 used in the wheel 50, the depth of the rim 52, the width of the rim 52, the lacing pattern of the wheel 50 (i.e., spoke crossing pattern or number of spokes 54 on each side of the wheel 50), the parameters that will be used in the algorithm for computing the number of spoke turns 122 to be used for each spoke 54, the desired final trueness of the wheel 50, or other parameters requested by the user interface. Other parameters might include by way of example only, and not by way of limitation, specifications of the final wheel 50 regarding lateral displacement, radial displacement, average tension for one or both sides of the wheel 50, tension range for one or both sides of the wheel 50, or dish.

The general purpose of steps 102, 103, and 104 are to obtain a written or electronic representation of the wheel 50. These steps need not be performed in the order listed above, and could be performed in any order, or some of these steps could be omitted. For example, it may be faster to acquire data and true a wheel 50 by only accruing lateral data and omitting dish measurement 102, radial data measurement, and tension measurement 104. As another example, a wheel could be trued with dish measurement 102, radial and lateral data measurement 103, but no tension measurement 104.

The data acquired by the client 128 in steps 102 through 105 is sent 106 to a server 127 for processing in one embodiment. Sending data 106 to the server 127 for processing is advantageous for several reasons. First, the server 127 might have a more powerful processor than the client 128. Further, the server 127 in one embodiment contains a library of data from many different clients that it learns from and uses to more efficiently solve the truing solutions from each of the client servers. In one embodiment, the server 127 saves data each time it is accessed by a client 128 to build a library of information from many different sources that it can use to make more informed calculations in the future.

The server 127 receives data at 120 and then retrieves influence function data from a library 121. Influence function refers to a relationship between a spoke or nipple adjustment and the corresponding effect on lateral runout, radial runout, and tension at all positions around the wheel. The influence functions are specific to a type of wheel 50 including spoke type, rim type, hub type, the number of spoke 54s, and any other physical components that make up the wheel 50. However, influence functions are similar for similar classes of wheels or types of components, so the influence need not be determined for the exact wheel being operated on.

The server 127 proceeds to determine a number of spoke turns 122 for each spoke 54. The server 127 uses the data provided by the client 128, which may include: wheel parameter data such as spoke type, rim type, hub type, and number of spokes 54; and wheel technical data including one or more of lateral runout at many positions around the wheel; radial runout at many positions around the wheel; spoke tensions of all or some of the spokes 54; desired final spoke tension after the truing process is complete; and the desired number of spokes 54 to adjust (or all of the spokes in many cases). The server 127 can also determine the number of spoke turns with only some of this information, but providing all of this information can sometimes give a better result than only providing some of this information. Determination of a number of spoke turns has been described previously by Papadopoulos (U.S. Pat. No. 5,103,414). Papadopoulos does not describe how to properly center, or dish, in the prior art, but an adaptation of the described process to also consider the movement of the rim with respect to the hub may be employed when making the determination. Furthermore, Papadopoulos does not describe how to reach a certain desired tension. After determining the number of spoke turns for all or a portion of the spokes 54 in the wheel 50, the server 127 may also determine the expected final state of the wheel 50 after the spoke adjustments are made 123. The final wheel data may include the final lateral runout, the final radial runout, and the final tension variation on one or both sides of the wheel 50. The server 127 then transmits these results to client 128 at 124 along with a list of the number of turns for each of the spokes 54 in the wheel 50 or a portion of the spoke 54s, if requested by the client 128.

Now that the server 127 has completed its portion of the process (which preferably takes less than a second, but could also take more time in some cases), the next step is for the client to program a drill 40 or other spoke tensioning device at 107. Drill 40 in this case refers to any device with a motor or other mechanism that is capable of turning spokes or spoke nipples in sufficiently precise increments of revolutions. For example, the drill 40 might refer a brushless DC motor with an encoder that is capable of being programmed to move between 0.01 and 10.00 revolutions in increments of 0.01 revolution at a rate of 4 revolutions per second. For instance, a Nema 17 brushless DC motor with an encoder, an integrated 15:1 gearbox, and with an attachment for turning spokes or spoke nipples can be used. In one embodiment, the operator places the drill 40 on the first spoke 54 on the right side of the wheel 50, presses a connected foot pedal, and the drill 40 automatically moves the prescribed number of turns. The operator proceeds to place the drill 40 on the second right side spoke 54, and so on, until all right side spokes 54 have been turned 108. The operator proceeds to turn the nipples on the left side of the wheel 109 in a similar fashion. The step 107 to program a drill 40 may be omitted if instead the instructions for turning nipples are provided to the operator for completion manually. For example, a computer screen (e.g. GUI 200 of client computer 128) could display the number of turns required and the operator could manually turn each nipple with a nipple wrench or other suitable tool for turning nipples. While sufficient, manually turning nipples may be less precise and more time consuming than using a drill 40 that turns automatically with a control system.

In another embodiment, the drill 40 has a trigger or a button on the handle of the drill 40 that the operator presses instead of using a using a foot pedal to actuate the drill 40. The drill 40 turns the nipples from the tire side of the rim 52 (i.e., the outside of the rim), or from the inside of the rim 52. Turning the nipples from the inside of the rim 52 might require an additional gearbox and mechanism that is capable of such task in the presence of a spoke passing through the nipple. Despite requiring a more complicated drill device than turning nipples from the outside of the rim 52, turning nipples from the inside of the rim 52 would typically be performed if an operator chooses to not remove a tire or otherwise does not have access to the opposite side of the nipples.

The client 128 then proceeds to measure dish 110, measure radial and lateral data 111, measure spoke tension 112 and send these data to the server 127 at 117, which then receives the data 125 and adds the data to its library 126. The data received from the client 128 allows the server 127 to compare the expected results to the actual results which may inform future wheel truing computations for the client that sent the data or an entirely different client in the future. The data sent from the client 128 to the server 127 could include dish, radial, lateral, and spoke tension data, or just a portion of this data, or none of this data.

The client 128 proceeds to determine if the wheel 50 meets specifications 113 pre-defined by the client 128, suggested by the server 127, or otherwise determined. If the wheel 50 has been satisfactorily trued such that the measured parameters such as one or more of lateral runout, radial runout, dish, average tension, and tension variation are within acceptable ranges, the process proceeds to end 114. However, if the wheel 50 does not meet specifications, the process reverts back to measure dish 102. Alternatively, if the system already has data recorded from steps 110 through 112, the process reverts back to step 106 instead. The process may also revert back to step 105 with the user changing inputs based on what parameters are out of specification. Steps 110, 111, and 112 can be described generally as quality control. Quality control could be omitted, but is generally used to ensure wheels meet specifications prior to conclusion of the process.

The process may complete the cycle of measuring wheel data, defining inputs, determining a number spoke turns, turning nipples, and quality control as many times as necessary to meet specifications. The process may be performed once for some types of wheels, but may be performed twice, three times, or more than three times for other types of wheels. In between the steps described above, other steps or processes may be carried out in some cases. For example, an additional step might be spoke destressing, or wheel pressing. This act of applying load to a wheel can help reduce stress concentrations in the spokes, nipples, rims, hubs, or other wheel components and might result in a wheel with better durability or longevity.

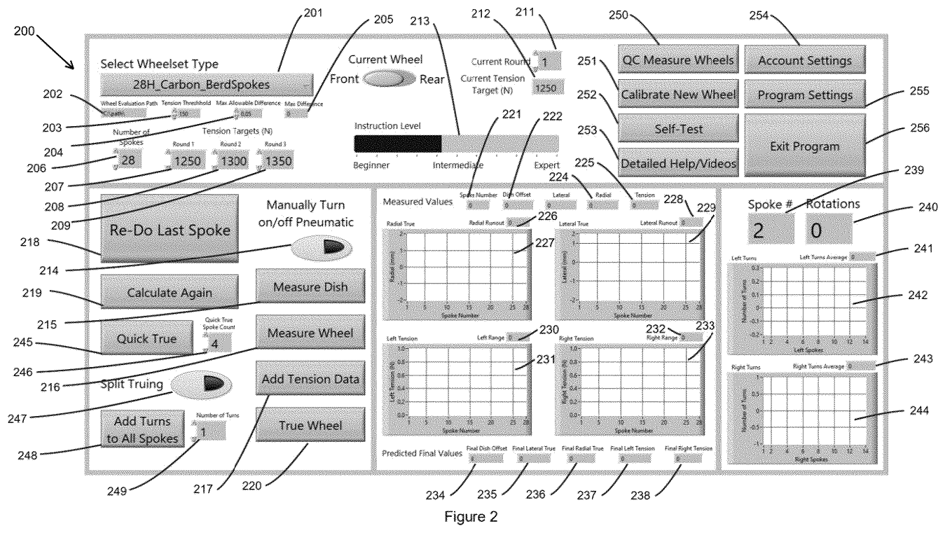

The interfaces by which a human operator completes the methods and steps described herein and communicates with the devices and computer may include audio, visual, haptic, and tactical interfaces. FIG. 2 shows one example of a GUI 200 used by an operator to execute wheel truing. The GUI 200 may be shown, for example, on client computer 128. It should be understood that additional interface components, or fewer interface components, or additional screens, may be used without departing from the scope of the disclosure. The interface in FIG. 2 is in one embodiment displayed on a computer monitor or tablet screen, and the buttons could be pressed by the operator using an input device or process such as a computer mouse, touching the screen directly, through audio commands given by the operator, or another similar method for depressing buttons and filling inputs on a screen, such as a keyboard. The interface might include all of the features shown in FIG. 2, or it might include just some of the features to create a more streamlined experience for the operator. While a GUI has been generally described, it should be understood that the system may have a set of tools available in the GUI. Representative GUI views are presented and described herein.

The example interface in FIG. 2 may be used by an operator whereby the operator begins the process by pressing the button to select the type of wheelset 201 that will be trued. The operator may then configure a file path on the computer by entering data into the field 202. Other fields for parameters that the operator may want to set, such as the tension threshold, or requested precision of the tension gathering instrument 203 or the maximum allowable precision for duplicate measurement of lateral and radial data acquisition 204 may then be completed by the operator. Indicator 205 may display the maximum difference in duplicate measurements taken by the program during wheel data acquisition.

The operator may proceed to input the number of spokes 206. The algorithm uses knowledge of the number of spokes 54 to determine the number of turns on each of the spokes 54. However, an alternative to the operator inputting this information would be for the system to automatically spin a wheel 50 with a motor 10 and roller 8 and use a sensor to count the number of spokes 54 present within the wheel 50 as it spins.

The operator may then input the spoke target tension in a certain type of unit usually used to measure tension (e.g., Newtons or kilograms of force), or an arbitrary unit defined by the device 12 that is used to measure spoke tension (e.g., millimeters of displacement in a 3-point bending tension measuring device). The interface may be set up to include one tension target for just 1 round of truing 207, or the interface may have inputs for target average wheel tensions at the completion of a first 207, second 208, and third 209 round of truing.

Other user inputs and display outputs on the graphical interface that an operator may use during step 105 described in the method include selection of front and rear wheel 210, selection of current round of truing 211, current tension target 212, and instruction level 213. The instruction level may be a useful tool for the operator to input the amount of instruction needed when truing a wheel. For example, an operator who has never used the GUI or is otherwise unfamiliar with some or all of the features of the system may benefit from the system providing voice text-to-speech instructions during some or all portions of the process. The result is that the system can effectively teach an operator how to perform tasks. On the other hand, a highly experienced operator may find excessive instruction detrimental in timely completion of the tasks involved and may set the instruction level 213 to “Expert.”

After defining user inputs 105, the operator in one embodiment physically places a wheel 50 ready to be trued into a device to measure dish and presses a button on the screen 215. Alternatively, the operator may press a connected foot pedal that recognizes this press as the indicator to measure the dish of the wheel 50. The machine may then use an audio output to tell the operator that the dish measurement was taken and instruct the operator to flip the wheel in the dish measurement gauge. After flipping the wheel 50 the operator may press the foot pedal again and the machine may use an audio output to tell the operator the recorded dish measurement. Audio outputs can be very convenient because they allow the operator to receive information while maintaining focus on a task without needing to look at a screen. Another input that a GUI may include is a user input for a desired final dish specification other than zero. A specification of zero refers to a wheel 50 where the midpoint of the rim 52 is centered over the midpoint of the hub. However, the operator may prefer that the midpoint of the rim 52 is offset with respect to the midpoint of the hub by a specific amount, such as 1.0 mm, for example. The operator could enter this value into the input which would instruct the algorithm to produce a wheel 50 as close as possible to this value.

The operator may then press a button 216 to measure the radial and lateral runouts using electronic digital displacement indicators (e.g., sensors 14 and 16 and contact 22) while the machine spins the wheel 50 with a motor 10 and roller 8, determines spoke positions with an infrared sensor, and records a measurements at the position of each spoke. Alternatively, the operator may press a connected foot pedal to begin this operation. The tension data could then be added subsequently to the set of data already acquired for the wheel by pressing a button 217 to begin this mode.

Some methods of measuring spoke tension, such as using a Wheel Fanatyk Tensiometer, require that the tensiometer is zeroed on each spoke prior to recording a measurement for that spoke. This often requires two inputs of a human operator in the form of foot pedal presses for each measurement. An alternative to that is shown in FIG. 3.

After the operator has completed all steps to measure data for a wheel 50 including dish, radial, lateral, and tension data as described above, the system might automatically send these data to the server 127 at 117 which will calculate a result for the spoke turns at 122 to true the wheel. Alternatively, the operator might review the measurements prior to deciding to send them to the server. During this review, if the operator determines that a measurement is inaccurate, the operator may use the interface to re-take one or more measurements prior to sending data to the server. Once the results of this calculation have been sent back to the client at 124, the system may use an audio output to alert the user that the machine is ready to true the wheel. The operator could then press a button 220 to true the wheel 50. If the operator is using an automated handheld drill (e.g., drill 40) pre-programmed with the results of the determination, the operator might press a button or foot pedal after placing the drill 40 on the first nipple, and then proceed to turn all spokes 54 on the wheel 50 in a similar fashion. If the operator makes a mistake during this process, or other processes, a button 218 to re-do the last spoke 54 may be provided. Another button 219 to send the data to the server 127 again for processing could be used in other cases where a change has been made to the user inputs.

Outputs that are either viewable by the operator on the screen, or given audibly to the operator by the machine using text-to-speech conversion, may be useful for a skilled or non-skilled operator to receive during operation of the machine. Examples of such outputs include but are not limited to: an indicator or display 221 for the current spoke number that measurements are being taken at during the data acquisition phase in the process; a display 222 of the measured dish offset; a display 223 of the current lateral runout measurement; a display 224 of the current radial runout measurement; a display 225 of the most recent tension measurement; a display 226 of the total radial displacement for the entire wheel; a display 228 of the total lateral displacement for the entire wheel; a graph 227 showing a 2-dimensional plot of the radial true as a function of spoke number; a graph 229 showing a 2-dimensional plot of the lateral true as a function of spoke number; a display 230 showing the range of all tension measurements taken on the left side of the wheel; a display 232 showing the range of all tension measurements taken on the right side of the wheel; a graph 231 showing a 2-dimensional plot of the tension measurements on the left side of the wheel as a function of spoke number; a graph 233 showing a 2-dimensional plot of the tension measurements on the left side of the wheel as a function of spoke number; a display 234 of the predicted final value of the dish offset of the wheel after truing is complete; a display 235 of the predicted final value of the total lateral displacement of the wheel after truing is complete; a display 236 of the predicted final value of the total radial displacement of the wheel after truing is complete; a display 237 of the predicted final value of the average tension of the left side of the wheel after truing is complete; a display 238 of the predicted final value of the average tension of the right side of the wheel after truing is complete; a display 239 showing the current spoke number during the turning nipples phases 108 or 109; a display 240 showing the number of rotations calculated by the server 127 for the current spoke; a display 241 showing the average number of turns calculated by the server 127 for the spokes on the left side of the wheel; a graph 242 showing a 2-dimensional plot of the number of turns calculated by the server 127 for each left side spoke as a function of the spoke number; a display 243 showing the average number of turns calculated by the server 127 for the spokes on the right side of the wheel; and a graph 244 showing a 2-dimensional plot of the number of turns calculated by the server 127 for each right side spoke as a function of the spoke number.

One standard method of truing includes adjustment of every spoke 54 on a wheel 50 (for example 28 spokes) based on the output of the truing determinations. Another simple adaptation of this is to turn or adjust the nipples on less than the full number of spokes 54. For example, if there is only a small discrepancy in the lateral displacement that is preventing a wheel from being within specifications, while all other metrics are within specification, a wheel 50 may only require an adjustment of one nipple to make the wheel 50 within all specifications. Or, maybe a wheel 50 requires adjustment of some other number of spoke nipples from two to one less than the total number of spokes 54. By turning less than the full number of spoke nipples to bring a wheel 50 into specification, the operator could save time compared to turning all of the spoke nipples. A button 245 may be present on the GUI to instruct the system to perform this quick method of truing. The operator may in one embodiment choose a number of spokes to be trued using the user input 246.

When truing the wheel in any mode, the operator may want to split the truing into two or more rounds such that they do not turn each spoke nipple by an amount of turns that might damage the wheel in a single pass. For example, the system may predict that the number of turns is approximately, or an average, of four turns on each spoke. Turning each spoke nipple sequentially in a single pass by four turns may cause a large imbalance of tension in the wheel and cause cracking or other damage to the rim. A button 247 allows the operator to split the truing into two or more rounds such that the number of turns on each spoke is divided by the number of rounds for turning with a first pass around the wheel, and then a second identical pass can be completed such that the total number of turns is completed after two passes. Another feature that an operator may use is a button 248 that allows the operator to turn every spoke by the same amount as defined in a user input 249. As is known, influence functions can determine the needed tension in each spoke and return a value indicating the needed tension, for example, the number of turns of the nipple to achieve the desired tension as described herein. If the operator desires to only change the tension in a selected number of spokes, the spokes can be ranked from those determined by the influence function requiring the largest change to those requiring the least, and the system can instruct the operator, based on the list and the number of spokes to be changed as selected by the operator, which spokes to adjust.

Other buttons that an operator may find useful on the GUI include but are not limited to: a button 250 that, when pressed, instructs the system to perform a measurement program designed specifically for quality control, which might be a scheme that takes less time than the normal method of measuring wheels for purposes of obtaining the necessary data to true a wheel; a button 251 to calibrate, or determine the influence function of, new wheels (as described by Papadopoulos); a button 252 that instructs the system to test hardware and server 127 functionality; a button 253 that brings the user to another interface for receiving additional help including written, video, or other resources; a button 254 that allows a user to access account settings; a button 255 that allows a user to access program settings; and a button 256 that allows a user to exit the program.

The GUI may also include a space for advertisements and buttons or links that allow users to purchase products associated with the primary functions of the machine, related products, or any other type of product.

In one example, the collection of lateral and radial displacement data 103 may be performed using the scheme depicted in FIG. 3. The process starts 301 with an operator mounting a wheel in a truing stand 302. Then, the operator places a rubber band position indicator (i.e., a rotational position indexing device 24) around the wheel rim 303 at the position of the valve hole in the rim 52. The purpose of placing this rubber band is that it will produce a characteristic spike in the lateral and/or radial displacement gauge that is characteristic with the dimensions of the rubber band. This in turn allows for the system to identify the position of the valve hole as it spins. Alternatively, a different object could be placed on or around the rim 52 such as a piece of tape or a sticker stuck to the rim lip that also interacts with the lateral and/or radial displacement gauge. The item placed on or around the rim 52 might preferably be removable and/or reusable. Furthermore, the position indicator may be placed on a rim 52 at any other location other than the valve hole but it is generally important that this position is consistent. After placing this object on the rim 52, the operator may check to see if the object interacts with the sensors 304 before moving on. The operator could then press a connected foot pedal 305 to instruct the system 1 that the wheel is ready to be measured. A different form of communication between the operator could be used such as but not limited to a mouse click, a keyboard stroke, an audio command, or the machine could begin measuring the wheel 50 without a command.

In this example, the system 1 then rotates the wheel 50 at a constant speed using a roller 8 connected to a computer-controlled motor 10, for example, and begins measuring lateral and radial data 306. The system 1 proceeds to analyze the data 307 to determine if the rubber band 24 is at the position of the lateral and/or radial sensor. The system might make this determination if the average of the last three lateral and/or radial data points minus the average of the last three lateral and/or radial data points is greater than criteria set by the system 1 or operator that is representative of a typical signal produced by the rubber band 24. When position indicator is found 308 the system 1 will begin to collect and store the lateral sensor 14 and radial sensor 16 displacement data 309 until the position indicator is found again 310 (i.e., after one complete rotation of the wheel 50).

The amount of data collected and stored could vary widely. Preferably, more data points than there are spokes in the wheel are collected and ideally, many more data points than there are spokes in the wheel are collected. For example, if the wheel is spun at a rate of one revolution per four seconds and data is collected at a rate of one data point per five milliseconds, the number of lateral and radial data points collected and stored would be 800. The lateral and radial data that is ultimately sent to the server 127 may correspond to one lateral and one radial data point per spoke. So, in this example, the system 1 might pick out and tabulate 311 the data points that are at the approximate location of each spoke using the assumption or knowledge that the spokes are evenly distributed around the wheel and that the valve hole is evenly spaced between two spokes. Simple algebra can then be used to pick out the location of those spokes from the larger data set. More sophisticated interpolation methods could also be used.

The system 1 may decide if two data sets have been obtained 312 before determining if those two data sets (which are intended to be duplicates) are within a tolerance specified by the operator or the machine 313. Alternatively, just one data set could be acquired and correspondingly no check to decide if the data sets are within a tolerance would be required. A benefit of collecting two data sets and comparing those data sets prior to proceeding is that this helps prevent anomalous data from negatively affecting the final results of the method. If the two data sets are not within tolerance, the system 1 might proceed to delete the first data set 314, acquire a new data set 309, and then compare the two most recently acquired data sets to check if they are within tolerance 313, and so on. Once the two data sets are within tolerance, the system 1 might stop rotating the wheel and end collection of the radial and lateral measurements 315. The operator might benefit from receiving the recorded measurements 316 in a visual format on the graphical interface, through audio cues, or some other method before this process ends 317.

Tasks that are likely to be performed by an operator 318 and those tasks that are likely to be performed by a machine or computer 319 are denoted by the dashed boxes.

FIG. 4 shows an example of a method for collecting tensiometer data 104 with a digital tensiometer (e.g., tensiometer 12) that is connected to a computer (e.g., client computer 128). The method starts 401 with tensiometer data collection 402. The tensiometer data may be collected in one embodiment at a rate of one data point every five milliseconds, but may be collected at a faster or slower rate instead. Some tensiometers require that a “zero” data point is collected prior to each measurement to account for the thickness of the spoke being measured. If the tensiometer requires zero 403, an audible command is sent from the machine to the operator to instruct the operator to zero the spoke along with an indication of which spoke should be measured 404 using a consistent measuring system. The operator then proceeds to place the tensiometer on the spoke 405. Simultaneously, the system records and displays the tensiometer data on a graphical interface 406. If the signal is stable and expected 407, the system proceeds to record and store the zero position value in memory 409. The definition of a stable signal could be that the tensiometer value has not changed an appreciable amount (i.e., by two percent) for at least 100 milliseconds. Other definitions for a stable signal might be used depending on the measurement device. The definition of an expected signal might be a signal that is within the range of possible measurement values for the tensiometer on that particular spoke type for all tensions that could possibly be in a wheel. Values outside of this might be deemed as anomalous. If the signal is not expected or stable, the operator might view the tensiometer data on the graphical interface and adjust the tensiometer 408.

After the zero position value is obtained and recorded 409, the system 1 provides an audible command of which spoke to measure 410 and the operator proceeds to position the tensiometer for tension reading 411. Similar to the zero position data measurement, the machine proceeds to record and display the tensiometer data on a graphical interface 412, determine if the signal is stable and expected 413, and record the data. If necessary, the operator could adjust the tensiometer position 414. After measuring the first spoke, the machine will proceed back to 403 and repeat the process for all spokes. Once the system has determined that the tension data has been collected for all spokes 415, the process ends 416.

Tasks that are likely to be performed by an operator 417 and those tasks that are likely to be performed by a machine or computer 418 are denoted by the dashed boxes.

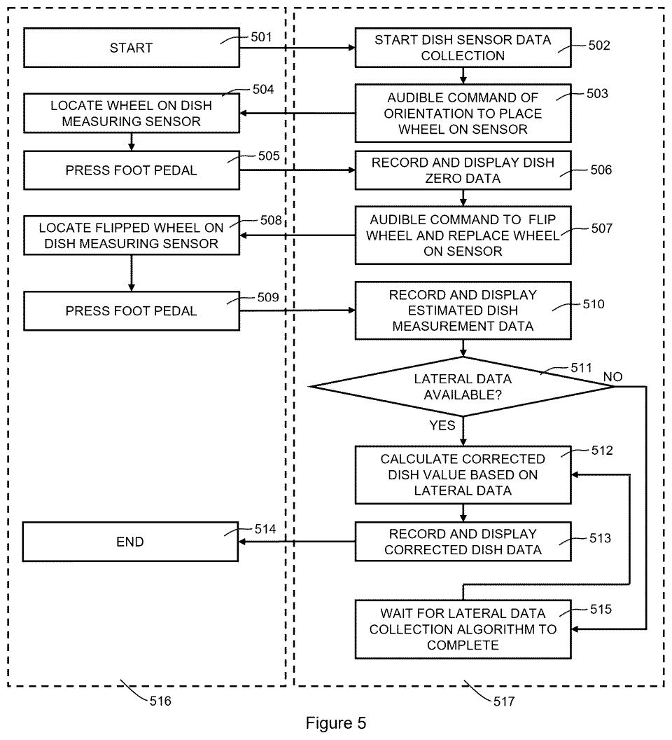

FIG. 5 shows an example of a method for collecting dish data. The method starts 501 with dish sensor data collection 502 using an electronic digital gauge connected to the computer, for example. The system might give an audible command of the orientation to place wheel 50 on the sensor 503 as a helpful reminder for the operator. For example, the system 1 might tell the operator to place the wheel 50 with the high tension side down and with the valve stem aligned with a certain position on the sensor. The operator proceeds to place the wheel 50 on the dish measuring sensor 504 and press a foot pedal 505 to indicate to the machine that the wheel is ready for the measurement to be recorded. The system 1 then proceeds to record the dish sensor data 506 and give an audible command to the operator 507, who then flips the wheel 50 and places the wheel 50 again on the dish measurement sensor 508. The operator presses the foot pedal 509 again and the system records a second dish measurement 510. The reported value of dish is the difference between the first and second measurements of the dish sensor. A difference of zero generally refers to a wheel 50 that is properly dished.

If the lateral position varies around the circumference of the wheel 50, the reported dish value may change as a function of the orientation by which the wheel 50 is placed on the dish sensor. Therefore, it is convenient to correct the dish to a value that refers to the average dish displacement, rather than a specific value relating to the orientation by which the wheel 50 was measured. If the lateral data has already been acquired for the wheel 511, the system 1 can proceed to calculate a corrected dish value 512, record and display the corrected dish data 513, and end 514. If the lateral data is not yet available, the system 1 must wait for the lateral data collection process to be completed later 515, and then proceed to calculate a corrected dish value 512, record and display the corrected dish data 513, and end 514. However, if dish is already measured by taking measurements around the circumference of the wheel, this process may not be required.

Tasks that are likely to be performed by an operator 516 and those tasks that are likely to be performed by a machine or computer 517 are denoted by the dashed boxes.

Each of the methods and processes described above may be performed partially, alone or in combination with other methods and processes, as a part of the overall disclosure. Methods and systems such as those described herein may be performed on computers and servers, and potentially in combination with user inputs and manual operations.

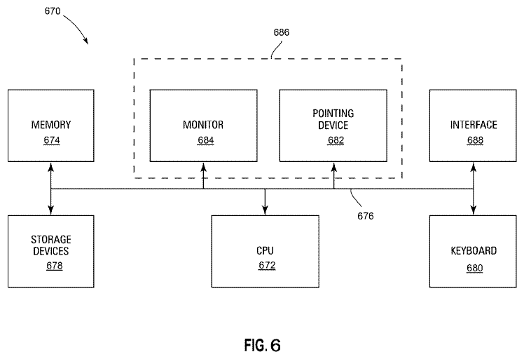

FIG. 6 shows a representative system that may be connected to and/or used to control embodiments of the present disclosure or a computer for those embodiments. The system described herein is usable on all the embodiments herein described and may be operable on a digital and/or analog computer. FIG. 6 and the related discussion provide a brief, general description of a suitable computing environment in which the computer can be implemented. Although not required, the computer can be implemented at least in part, in the general context of computer-executable instructions, such as program modules, being executed by a computer 670 which may be connected in wired or wireless fashion to the computer. Generally, program modules include routine programs, objects, components, data structures, etc., which perform particular tasks or implement particular abstract data types. Those skilled in the art can implement the description herein as computer-executable instructions storable on a computer readable medium. Moreover, those skilled in the art will appreciate that the invention may be practiced with other computer system configurations, including multi-processor systems, networked personal computers, mini computers, main frame computers, and the like. Aspects of the invention may also be practiced in distributed computing environments where tasks are performed by remote processing devices that are linked through a communications network. In a distributed computer environment, program modules may be located in both local and remote memory storage devices.

The computer 670 comprises a conventional computer having a central processing unit (CPU) 672, memory 674 and a system bus 676, which couples various system components, including memory 674 to the CPU 672. The system bus 676 may be any of several types of bus structures including a memory bus or a memory controller, a peripheral bus, and a local bus using any of a variety of bus architectures. The memory 674 includes read only memory (ROM) and random access memory (RAM). A basic input/output (BIOS) containing the basic routine that helps to transfer information between elements within the computer 670, such as during start-up, is stored in ROM. Storage devices 678, such as a hard disk, a floppy disk drive, an optical disk drive, etc., are coupled to the system bus 676 and are used for storage of programs and data. It should be appreciated by those skilled in the art that other types of computer readable media that are accessible by a computer, such as magnetic cassettes, flash memory cards, digital video disks, random access memories, read only memories, and the like, may also be used as storage devices. Commonly, programs are loaded into memory 674 from at least one of the storage devices 678 with or without accompanying data.

Input devices such as a keyboard 680 and/or pointing device (e.g. mouse, joystick(s)) 682, virtual controller such as a virtual reality (VR) set or an augmented reality (AR) set, foot pedals or the like, allow the user to provide commands to the computer 670. The input devices further comprise each of the sensing devices described above. A monitor 684 or other type of output device can be further connected to the system bus 676 via a suitable interface and can provide feedback to the user. If the monitor 684 is a touch screen, the pointing device 682 can be incorporated therewith. The monitor 684 and input pointing device 682 such as mouse together with corresponding software drivers can form a graphical user interface (GUI) 686 for computer 670. Interfaces 688 on the computer 670 allow communication to other computer systems such as via the peer-to-peer embodiments discussed above. Herein the monitor 684 further represents a speaker or tactile device worn or used by the operator. Interfaces 688 further represent interfaces for other devices under the control of the computer such as the drill or other computer controlled devices such as motors or other devices described above.

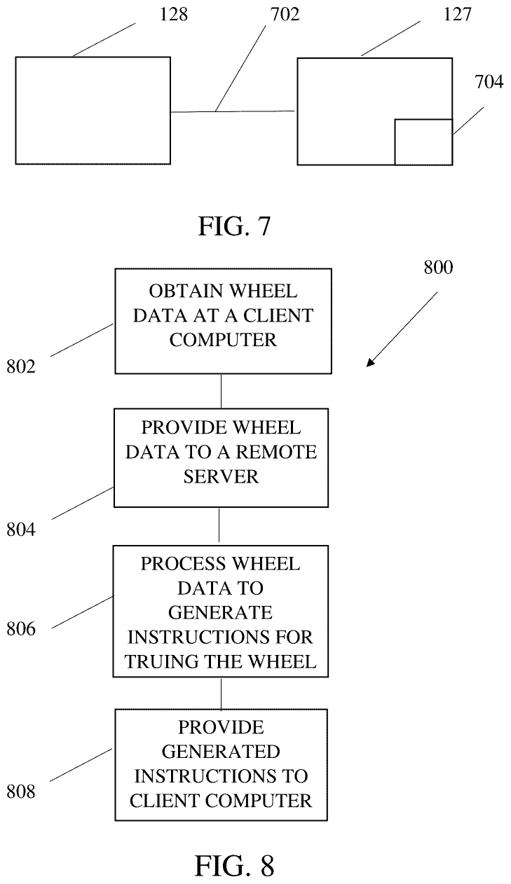

FIG. 7 shows a client/server system 700 that may be used in conjunction with embodiments of the present disclosure. System 700 comprises in one embodiment a client side computer such as client 128, and a server side computer such as server 127, communicatively connected by a wired or wireless connection 702. Such connections 702 are known in the art and will not be further described herein. Client 128 and server 127 maybe a computer such as computer 670, with additional components such as those described above. Further, server 127 includes in one embodiment a database 704 of wheel truing information.

The spoked wheel truing system 700 in one embodiment includes a client computer 128 configured with a GUI to collect data on a wheel, and a remote server 127 configured to communicate with the client computer to receive the collected data, to process the collected data server to generate instructions on truing the wheel, and to provide the generated instructions to the client computer.

Generated instructions in one embodiment include a number of turns to be imparted to each spoke of the wheel. The server 127 may further be configured to collect data on the wheel by collecting wheel parameter data and collecting wheel technical data. Wheel parameter data collection is described generally above at block 105. Wheel technical data is described generally above at 102, 103, and 104. Additional wheel parameter data and wheel technical data may also be obtained as discussed herein.

The remote server 127 is further configured in one embodiment to process the collected data at the remote server by identifying the wheel with the wheel parameter data, retrieving predetermined wheel technical data for a properly trued wheel from a database resident on the remote server, and applying the wheel technical data to the predetermined wheel technical data for generating the instructions for truing the wheel.

FIG. 8 illustrates a method 800 of truing a spoked wheel 50. Method 800 comprises, in one embodiment, obtaining wheel data at a client computer 128 in block 802, and providing the wheel data to a remote server 127 in block 804. The remote server 127 processes the wheel data to generate instructions for truing the wheel 50 at block 806. The generated instructions are provided to the client computer 128 at block 808.

The method may further include displaying, on a GUI 200 of the client computer 128, the generated instructions. The method may further include truing the wheel 50 with the generated and displayed instructions. The generated instructions comprise in one embodiment a number of turns to be imparted to each spoke 54 of the wheel 50.

In one embodiment, processing comprises comparing wheel data information to a database of wheel technical data for a properly trued wheel, the database resident on the remote server, and applying the wheel technical data to the predetermined wheel technical data for generating the instructions for truing the wheel. In one embodiment, obtaining wheel data comprises obtaining wheel parameter data and obtaining wheel technical data. Obtaining wheel data may be performed is performed by initiating wheel technical data measurements at a GUI of the client computer, the GUI operating on software at the client computer to operate a system for obtaining the wheel technical data measurements.

Although the present disclosure has been described with reference to preferred embodiments, workers skilled in the art will recognize that changes may be made in form and detail without departing from the spirit and scope of the disclosure.

1. A spoked wheel truing system, comprising:
a client computer configured with a graphical user interface to collect data on a spoked wheel;
the client computer configured to:
communicate with a remote server to send the collected data to the remote server; and
receive from the remote server processed data comprising generated instructions on truing the spoked wheel.

2. The spoked wheel truing system of claim 1, wherein the client computer is further configured to collect data on the spoked wheel by collecting wheel parameter data and collecting wheel technical data.

3. The spoked wheel truing system of claim 2, wherein the client computer is further configured to collect wheel parameter data defining the spoked wheel including at least one of wheel brand, wheel size, number of spokes, type of spokes, wheel hub type, rim type, and spoke lacing pattern.

4. The spoked wheel truing system of claim 2, wherein the client computer is further configured to collect wheel technical data including at least one of a dish measurement for the spoked wheel, radial and lateral true data for the spoked wheel, and spoke tension for spokes of the spoked wheel.

5. The spoked wheel truing system of claim 4, wherein the client computer is further configured to collect spoke tension for spokes of the spoked wheel from a tensiometer.

6. The spoked wheel truing system of claim 5, wherein the client computer receives spoke tension data from the tensiometer through operation of a coupled transmitter on the tensiometer.

7. The spoked wheel truing system of claim 6, wherein the client computer is configured to process the received spoke tension data from the tensiometer and determine when the spoke tension data is stable based on a stability criteria.

8. The spoked wheel truing system of claim 4, and further comprising: a rotational positioning device affixable at a known location on the spoked wheel; wherein the client computer is further configured to identify the presence of the rotational positioning device to allow for identification of the known location.

9. The spoked wheel tuning system of claim 8, wherein the rotational positioning device is a rubber band.

10. The spoked wheel truing system of claim 1, and further comprising a spoke adjustment tool coupled to the client computer and controlled thereby, the spoke adjustment tool configured to perform the truing instructions received by the client computer on spokes of the spoked wheel.

11. The spoked wheel truing system of claim 10, wherein the spoke adjustment tool is a drill.

12. The spoked wheel truing system of claim 1, wherein the generated instructions comprise a number of turns to be imparted to at least a spoke of the spoked wheel.

13. The spoked wheel truing system of claim 1, wherein the generated instructions comprise a number of turns to be imparted to a subset of the spokes of the spoked wheel.

14. The spoked wheel truing system of claim 13, wherein the generated instructions comprise a number of turns to be imparted to each spoke of the spoked wheel.

15. The spoked wheel truing system of claim 2, wherein the client computer is further configured to transmit the collected data to the remote server, and to receive processed data determined by identifying the spoked wheel with the wheel parameter data, retrieving predetermined wheel technical data for a properly trued wheel from a database resident on the remote server, and applying the wheel technical data to the predetermined wheel technical data for generating the instructions for truing the spoked wheel.

16. A method of truing a spoked wheel, comprising:
obtaining wheel data at a client computer;
providing the wheel data to a remote server;
receiving from the remote server processed instructions for truing the spoked wheel determined by the remote server.

17. The method of claim 16, and further comprising displaying, on a graphical user interface of the client computer, the instructions.

18. The method of claim 17, and further comprising truing the spoked wheel with displayed instructions.

19. The method of claim 16, and further comprising truing the spoked wheel with the instructions.

20. The method of claim 16, wherein the instructions comprise a number of turns to be imparted to each spoke of the spoked wheel.

21. The method of claim 16, wherein the instructions comprise a number of turns to be imparted to at least a spoke of the spoked wheel.

22. The method of claim 16, wherein the instructions comprise a number of turns to be imparted to a subset of the spokes of the spoked wheel.

23. The method of claim 16, wherein processed instructions received from the remote computer include wheel data information compared to a database of predetermined wheel technical data for a properly trued wheel, the database resident on the remote server, and applying the wheel technical data to the predetermined wheel technical data for generating the instructions for truing the spoked wheel.

24. The method of claim 16, wherein obtaining wheel data comprises obtaining wheel parameter data and obtaining wheel technical data.

25. The method of claim 24, wherein obtaining wheel data is performed by initiating wheel technical data measurements at a graphical user interface of the client computer, the graphical user interface operating on software at the client computer to operate a system for obtaining the wheel technical data measurements.

26. The method of claim 16, wherein obtaining wheel data comprises collecting wheel parameter data and collecting wheel technical data.

27. The method of claim 26, wherein collecting wheel parameter data comprises collecting data defining the spoked wheel including at least one of wheel brand, wheel size, number of spokes, type of spokes, wheel hub type, rim type, and spoke lacing pattern.

28. The method of claim 26, wherein collecting wheel technical data comprises collecting at least one of a dish measurement for the spoked wheel, radial and lateral true data for the spoked wheel, and spoke tension for spokes of the spoked wheel.

29. (canceled)

30. (canceled)
